(19) United States
(12) Patent Application Publication
(10) Pub. No.: US 2014/0029005 A1
(43) Pub. Date: Jan. 30, 2014

(54) METHOD AND DEVICE FOR DETERMINING AN OPTICAL CLARITY THROUGH A CAR WINDOW

(71) Applicants: Reinhold Fiess, Durbach (DE); Annette Frederiksen, Renningen (DE)

(72) Inventors: Reinhold Fiess, Durbach (DE); Annette Frederiksen, Renningen (DE)

(21) Appl. No.: 13/983,103

(22) PCT Filed: Dec. 15, 2011
(86) PCT No.: PCT/EP2011/072905

§ 371 Date: Oct. 10, 2013

(30) Foreign Application Priority Data
Feb. 8, 2011 (DE) 10 2011 003 803.5

(51) Int. Cl. G01N 21/21

(52) U.S. Cl. CPC G01N 21/21
USPC 356/364

(57) ABSTRACT

A method for determining a clarity of a window of a vehicle has a step of evaluating an information item of at least one light beam furnished with a predetermined polarization in order to determine the clarity of the window.

### BACKGROUND OF THE INVENTION

1. Field of the Invention

The present invention relates to a method for emitting and receiving at least one light beam for determining a clarity of a window of a vehicle.

2. Description of the Related Art

Published German patent application document DE 3532199A1 describes a sensor that utilizes the disruption of the total reflection of a light bundle by water drops on a window. The attenuation by the window of light transmission from a transmitter to a receiver is an indication of the clarity, and it is used in order to maintain the latter at a setpoint, for example by initiating wiping operations.

### BRIEF SUMMARY OF THE INVENTION

The invention is based on the recognition that in the context of a video-based rain sensor, advantages can be achieved with respect to previously known rain sensors, in particular with regard to image contrast, by the use of polarized light as additional illumination. In addition, it is also possible to work with multiple polarization directions in the context of illumination. Further improvements in the video-based rain sensor result therefrom.

Polarized illumination results in an increase in the contrast of an image acquired of a window. This makes possible more reliable detection of rain, dirt, and defects. It is thereby possible to eliminate the problem that when the ambient background is uniform, for example at night, drops can be detected only with difficulty or not at all. More reliable rain detection yields better driver visibility, including at night. The invention thus makes possible an increase in driving safety, and decreases the risk of an accident due to poor visibility through the windshield. A decrease in clarity is reliably detected and countermeasures can be taken, for example an actuation of the windshield wiping system.

The present invention creates a method for determining a clarity of a window of a vehicle, having the following steps:

evaluating an information item of at least one light beam furnished with a predetermined polarization, in order to determine the clarity of the window.

The clarity of a vehicle window, which can be understood as a windshield of a vehicle, can be impaired by a variety of factors such as, for example, precipitation in the form of rain or snow, dirt, or defects such as, for example, cracks or pits due to stone impacts caused by preceding vehicles, and the like. In order to maintain optimum clarity of the window, in the event of impairment due to one or more of the aforementioned influencing factors, suitable countermeasures must be taken, for example cleaning the window using the windshield wiping system of the vehicle or also prompt replacement of the window if a defect exists. Detection of a defect is also important, so that the windshield wiping system is not actuated unnecessarily because the defect is incorrectly interpreted as dirt. In order to keep the window clear of precipitation and dirt, an apparatus, e.g. a video-based rain sensor, for monitoring the clarity of the window is coupled to the windshield wiping system. The clarity of the vehicle window is determined on an optical basis. For this, light beams arriving at a detector of the rain sensor and proceeding from the window are evaluated. The light beams supply information items that can be converted by the detector into image information. In other words, a video-based rain sensor acquires at least one image of the window, from which image conclusions can be drawn as to clarity. Two images of the window can also be acquired and compared with one another in order to determine the clarity. The information of the at least one light beam furnished with the predetermined polarization is contained in at least one image. The predetermined polarization can be a linear or circular polarization. Determination and evaluation of the information can occur in a suitable electronic system that interacts with the optical devices of the video-based rain sensor, by way of a suitable image processing algorithm.

The present invention further creates a method for emitting at least one light beam suitable for determining a clarity of a window of a vehicle, having the following steps:

directing onto the window at least one light beam furnished with a predetermined polarization.

The at least one light beam can be emitted using at least one light source. The light source can be, for example, a light-emitting diode, a laser, or the like. The at least one light beam can be directed onto the window, using suitable optical devices, in such a way that at least a portion of the light is reflected at precipitation drops or contaminants on the side of the window external to the vehicle, and can be sensed by a detector. The clarity of the window of the vehicle can be determined on the basis of this reflection. For example, an unpolarized light beam and a polarized light beam, or multiple differently polarized light beams, can be emitted.

According to an embodiment, a step of generating the at least one light beam furnished with the predetermined polarization can be executed using at least one polarized light source. The polarized light source can have, for example, a laser light source. A laser light source can emit polarized light. A polarization direction of the at least one light beam can also be predetermined by the laser light source. The at least one light beam can also be generated alternatingly using respectively one of, for example, two laser light sources of differing polarization directions. Multiple light beams can also be generated by multiple differently polarized light sources. If the predetermined polarization is brought about by way of the light source, transmission-side polarizers for sending out the at least one light beam can then be omitted. Space savings can be obtained thereby, and the number of installed parts can be decreased.

A step of generating the at least one light beam furnished with the predetermined polarization can also be executed using at least one polarizer. In order to polarize the at least one light beam, the polarizer can have a polarizing filter or a suitable prism, a twisted nematic cell, or the like. The polarizer can have control selectively applied to it in order either to polarize the light beam, allow it to pass in unpolarized fashion, or modify its polarization. The polarizer can generate a linear polarization or a circular polarization. The polarizer can be disposed after the light source in the photon flux direction. It is also possible, for example, to provide two polarizers to which, for example, control can be selectively applied, in order to polarize the light beam deriving from a light source in, for example, one of two predetermined manners. This offers the advantage that a light source for unpolarized light can also be used, and at least one predetermined polarization in the context of at least one light beam can nevertheless be brought about. This enables savings in terms of both space and cost and minimizes the number of light sources, with complete flexibility in terms of polarization.

The present invention further creates a method for receiving at least one light beam suitable for determining a clarity of a window of a vehicle, having the following steps:

polarizing, using at least one polarizer, at least one light beam which represents a light beam deriving from the window, in order to generate at least one light beam furnished with a predetermined polarization; and

sensing by way of a detector the at least one light beam furnished with the predetermined polarization.

The detector can be a suitable light-sensitive sensor, for example a charge coupled device (CCD) sensor or a so-called imager. The detector can be part of a video camera assemblage of the video-based rain sensor. In the detector, the light of the received light beam is converted into evaluatable electrical signals in a manner known in the sector.

According to an embodiment, in the polarizing step the at least one light beam that represents the light beam deriving from the window can be polarized using a polarizer that is adjustable in terms of its polarizing effect, in order to generate chronologically successive light beams having different predetermined polarizations. In the sensing step, the chronologically successive light beams can be sensed using the detector. The polarizer that is adjustable in terms of its polarizing effect can have control selectively applied to it in order either to polarize light beams, allow them to pass without polarization, or modify their polarization. The polarizer can generate chronologically successive light beams having different linear polarizations or having different states of a circular polarization. For example, different linear polarizations can be oriented approximately normal to one another. In the context of a circular polarization, the different polarization states of the chronologically successive light beams can exhibit different rotation angles, such that the rotation angle changes as a function of time. More than one receiving-side polarizer can also be used in this context. The polarizer can be disposed in front of the detector in the photon flux direction. This kind of embodiment of the present invention offers the advantage that using a polarizer placed in front of the detector, the flexibility and accuracy with which the clarity of the window is determined can be increased. The use of an adjustable polarizer economizes on space and components, and at the same time offers more versatile adjustment and evaluation capabilities for the light beams for determining the clarity of the window.

The at least one light beam deriving from the window can represent a light beam that has penetrated at least once through the window. If the light beam strikes the window from outside, the light beam can penetrate through the window and can then be received by the detector. If the light beam strikes the window from inside, the light beam can be reflected once or repeatedly at interfaces of the window and can then be received by the detector. In the context of a dry surface of the window, the light can thus be reflected once or repeatedly at the outer interface of the window. If, for example, water drops are present on the window, a portion of the light is outcoupled at the outer interface of the window, and results in a lower intensity at the detector. The decrease in the quantity of light received at the detector permits conclusions as to the rain intensity and thus the clarity of the window. The more water that is present on the window, the greater the quantity of light coupled out, and the lower the reflection and thus also the clarity. The reflection behavior of the light beam at the window can thus be utilized in order to determine the clarity of the window; this simplifies, in particular, the detection of precipitation.

The present invention furthermore creates a method for identifying a clarity of a window of a vehicle, which method encompasses the steps of the above method for receiving at least one light beam suitable for determining a clarity of a window of a vehicle and the steps of the above method for determining a clarity of a window of a vehicle, and additionally or alternatively the steps of the above method for emitting at least one light beam suitable for determining a clarity of a window of a vehicle.

The method for identification can be used in a sensor system that has a receiving device for receiving a light beam and additionally either a transmitting device for emitting a light beam or an evaluation device for evaluating the light beam received by the receiving device, or both the transmitting device and the evaluation device.

The present invention furthermore creates an apparatus for determining a clarity of a window of a vehicle, the apparatus being embodied to carry out or implement the steps of one of the methods according to the present invention in corresponding devices. This variant embodiment of the invention in the form of an apparatus also allows the underlying object of the invention to be quickly and efficiently achieved. In particular, the apparatus can be a receiving apparatus for receiving at least one light beam suitable for determining a clarity of a window of a vehicle, a transmitting apparatus for emitting at least one light beam suitable for determining a clarity of a window of a vehicle, and an evaluation device for determining a clarity of a window.

An “apparatus” can be understood in the present case as an electrical device that processes sensor signals and outputs control signals as a function thereof. The apparatus can also have optical elements in order to make available the corresponding optical functionalities. The apparatus can have an interface that can be embodied in hardware- and/or software-based fashion. In a hardware-based embodiment the interfaces can be, for example, part of a so-called “system ASIC” that contains a wide variety of functions of the apparatus. It is also possible, however, for the interfaces to be separate integrated circuits, or to be made up at least in part of discrete components. In a software-based embodiment, the interfaces can be software modules that are present, for example, on a microcontroller alongside other software modules.

Also advantageous is a computer program product having program code which can be stored on a machine-readable medium such as a semiconductor memory, a hard-disk memory, or an optical memory and is used to carry out one of the methods according to one of the embodiments described above when the program is executed on a device corresponding to a computer.

### BRIEF DESCRIPTION OF THE DRAWINGS

FIG. 1 schematically depicts an image detector.

FIG. 2 shows an image acquired using the image detector of FIG. 1.

FIG. 3A is a perspective view of a video-based rain sensor.

FIG. 3B is a perspective view of a portion of the elements of the video-based rain sensor of FIG. 3A.

FIG. 4 is a flow chart of a method according to an exemplifying embodiment of the present invention.

FIGS. 5A and 5B schematically depict an apparatus according to an exemplifying embodiment of the present invention.

FIG. 6 is a flow chart of a method according to an exemplifying embodiment of the present invention.

FIG. 7A schematically depicts an apparatus according to an exemplifying embodiment of the present invention.

FIG. 7B schematically depicts an apparatus according to an exemplifying embodiment of the present invention.

FIG. 8 is a flow chart of a method according to an exemplifying embodiment of the present invention.

FIG. 9 schematically depicts an apparatus according to an exemplifying embodiment of the present invention.

FIG. 10 is a flow chart of a method according to an exemplifying embodiment of the present invention.

### DETAILED DESCRIPTION OF THE INVENTION

In the description below of preferred exemplifying embodiments of the present invention, identical or similar reference characters are used for the elements that are depicted in the various Figures and function similarly, repeated description of those elements being omitted.

FIG. 1 schematically depicts an image detector 100. Image detector 100 can be installed, for example, in a video-based rain sensor of a vehicle. Image detector 100 can be, for example, a so-called image array. Image detector 100 has an assemblage of image elements or pixels that are disposed in rows and columns. In FIG. 1, for example, for the sake of better clarity 17 pixels are depicted along a height dimension h of image detector; it should be clear that in practice image detector 100 can have more pixel cells, for example 512 pixel cells. In addition, for the sake of better clarity 27 pixels, for example, are shown in FIG. 1 along a width dimension b of image detector 100. Here as well, it should be clear that image detector 100 can in practice have more pixels in each pixel row, for example 1024 pixels per row.

Image detector 100 of FIG. 1 has, in an upper portion thereof, a primary image region 110 for acquisition or sensing of a primary image, and in a lower portion a secondary image region 120 for acquisition or sensing of a secondary image. Primary image region 110 is a region of image detector 100 that is used, for example, for video assistance functions. Secondary image region 120 is a region of image detector 100 that is used for the rain sensor function. Secondary image region 120 can encompass, in practice, 30 pixel rows. Primary image region 110 occupies a larger number of pixels of image detector 100 than secondary image region 120. The primary image and secondary image are produced as a result of light that is directed by way of optical elements onto image detector 100. The primary image can be focused, for example, at a distance of approximately 15 m, and the secondary image can be focused, for example, at a distance of approximately 5 to 10 cm. If image detector 100 is used to operate a video-based rain sensor in a vehicle, the primary image thus images a region in front of the vehicle and the secondary image images the windshield with any water drops or contaminants or defects.

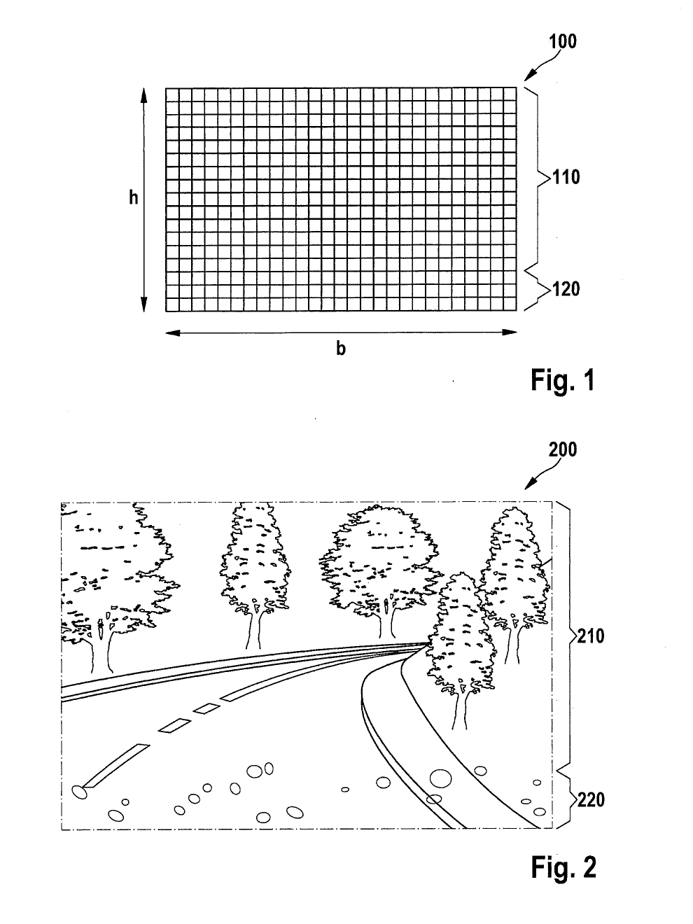

FIG. 2 shows an image 200 acquired by way of the image detector of FIG. 1. Image 200 has in an upper portion a primary image 210, and in a lower portion a secondary image 220. Primary image 210 shows a road segment, for example in front of a vehicle, and is focused at a distance of, for example, 15 m. Secondary image 220 is focused onto the windshield of the vehicle, for example at a distance of 5 to 10 cm, and shows multiple raindrops on the window. Primary image 210 can be sensed by way of the primary image region of the image detector of FIG. 1. Secondary image 220 can be sensed by way of the secondary image region of the image detector of FIG. 1.

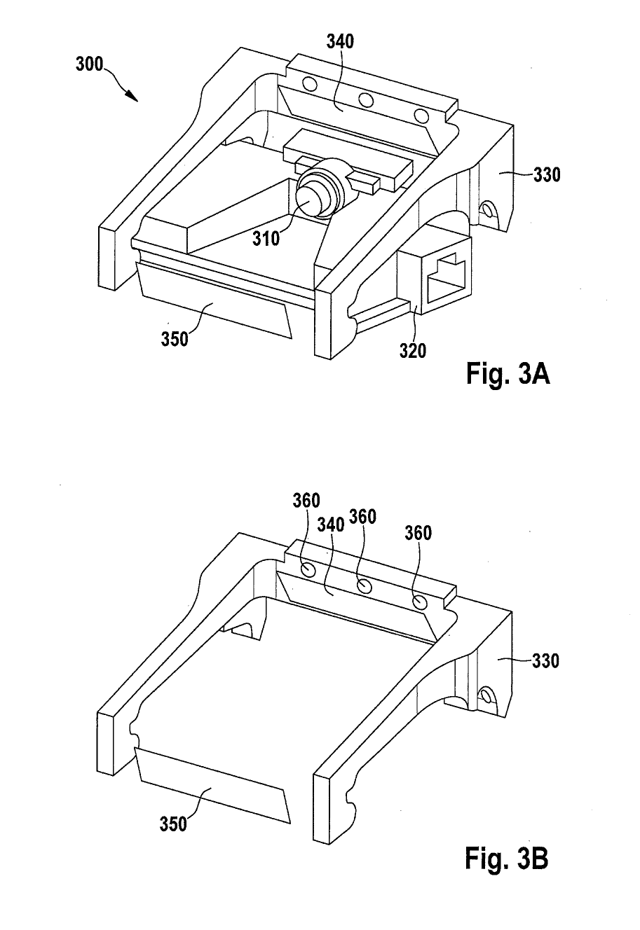

FIG. 3A is a perspective view of a video-based rain sensor 300. A camera 310, a camera mount 320, a mirror mount 330, a folding mirror 340, and a main mirror 350 are shown. Rain sensor 300 can be installed in a vehicle, for example a passenger car. Rain sensor 300 can be disposed close to an inner surface of a windshield of the vehicle. For example, mirror mount 330 can be attached to the windshield, and camera mount 320 can be part of an upper dashboard cover of the vehicle.

Camera 310 is received in camera mount 320. Camera mount 320 is a shaped element having a substantially rectangular base outline. Camera mount 320 is embodied so that a light beam can reach camera 310 without impediment by camera mount 320. In FIG. 3A, mirror mount 330 is slipped over camera mount 320 having camera 310. Mirror mount 330 is a frame-shaped component having four legs and a U-shaped main frame. Each of the legs rests, for example, on the upper dashboard cover in the region of a corner of the rectangular base outline of camera mount 320. The legs carry the main frame in such a way that the latter is disposed, in FIG. 3A, above camera mount 320 and camera 310. A principal extension plane of mirror mount 330 can be inclined with respect to a principal extension plane of camera mount 320. Folding mirror 340 is disposed on a transverse connection of the U-shaped main frame of mirror mount 330. Main mirror 350 is disposed between the free ends of the U-shaped main frame of mirror mount 330. Folding mirror 340 and main mirror 350 substantially face toward one another. Although this is not explicitly depicted in FIG. 3A, main mirror 350 can thus be connected to mirror mount 330. The connection can be designed in such a way that main mirror 350 can be rotated at least along a principal extension direction thereof.

The exact disposition, orientation, and shape of the elements of rain sensor 300 depend on circumstances in the vehicle, in particular on the size and shape of the windshield as well as the angle of the windshield with respect to the upper dashboard cover. Rain sensor 300 is embodied overall in such a way that a light beam incident from the windshield of the vehicle first strikes folding mirror 340, is reflected therefrom to main mirror 350, and is directed from main mirror 350 to camera 310. Camera 310 can encompass the image detector of FIG. 1. A refocusing operation, and thus division into the primary image and secondary image, can be implemented by a specific conformation of one of mirrors 340, 350.

FIG. 3B is a perspective view of a portion of the elements of the video-based rain sensor of FIG. 3A. Mirror mount 330, folding mirror 340, and main mirror 350 of the rain sensor of FIG. 3A are shown, as well as additionally three light sources 360. A U-shaped surface, depicted at the top in FIG. 3B. of the main frame of mirror mount 330 represents a windshield attachment surface at which the rain sensor can be attached to the windshield of the vehicle. The three light sources 360 are disposed in a line on mirror mount 330. More precisely, the light sources in FIG. 3B are disposed, above folding mirror 340, on or in mirror mount 330 in a line parallel to a longitudinal extension direction of folding mirror 340. Light sources 360 can be light-emitting diodes or LEDs, laser light sources, or the like. Light sources 360 are oriented so that light beams emitted from them strike the windshield of the vehicle when the rain sensor is installed in a vehicle.

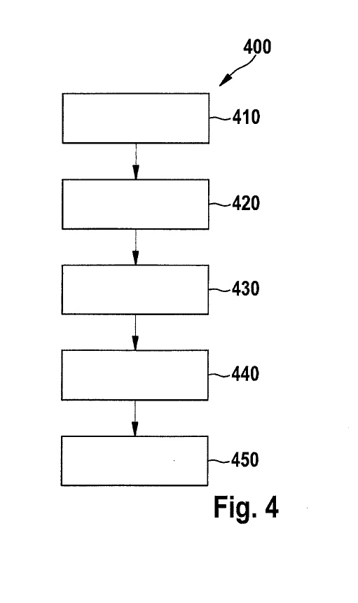

FIG. 4 is a flow chart of a method 400 for determining a clarity of a window of a vehicle, according to an exemplifying embodiment of the present invention. Method 400 begins with a step of generating 410, using at least one polarized light source, at least one light beam furnished with a predetermined polarization. Alternatively, the corresponding light beam can be generated using at least one polarizer. Method 400 then has a step of directing 420 onto the window the at least one light beam furnished with the predetermined polarization. The light beam then strikes the window is partly reflected by the window or by precipitation, dirt, and/or a defect on the outer side of the window. Method 400 then has a step of polarizing 430, using at least one polarizer, at least one light beam deriving from the window in order to generate at least one light beam furnished with a predetermined polarization. The light beam deriving from the window can be the light beam generated in step 410, or a part of said beam. Alternatively, it can be a light beam deriving from outside the vehicle. Method 400 further has a step of sensing 440, using at least one detector, the at least one light beam furnished with the predetermined polarization. Lastly, the method has a step of evaluating 450 an information item of the at least one light beam furnished with the predetermined polarization in order to determine the clarity of the window. Method 400 can advantageously be executed, for example, in conjunction with the image detector of FIG. 1 and/or the rain sensor of FIGS. 3A and 3B.

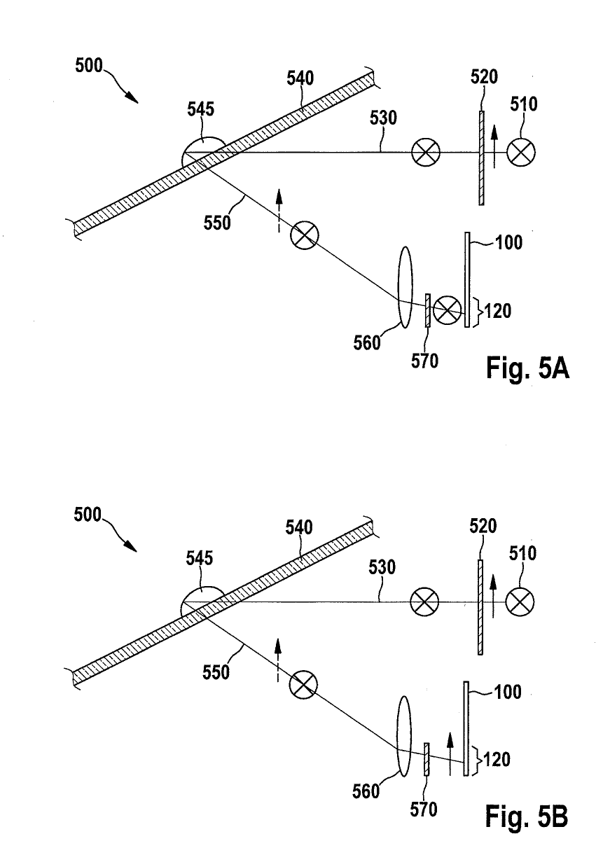

FIG. 5A schematically depicts an apparatus 500 for determining a clarity of a window of a vehicle, according to an exemplifying embodiment of the present invention. An image detector 100 having a secondary image region 120 is shown. Also shown are a light source 510, a polarizer 520, an emitted light beam 530, a window 540, a water drop 545, a reflected light beam 550, an objective 560, and an analyzer 570. Image detector 100 having secondary image region 120 can correspond to the detector described with reference to FIG. 1. Image detector 100, secondary image region 120, objective 560, and analyzer 570 can be parts of a camera, for example the camera of the rain sensor of FIGS. 3A and 3B. Light source 510 can represent one of the light sources of FIG. 3B. Further ones of elements 100, 510, 520, 560, 570 can be provided in order to emit further beams 530 or receive further beams 550.

Emitted light beam 530 can be generated using light source 510. Light source 510 can have, for example, a light-emitting diode or a laser light source. After emission by light source 510, emitted light beam 530 first strikes polarizer 520. Polarizer 520 can be adjustable in terms of its polarizing effect on emitted light beam 530. This is advantageous in order to take into account different installed light sources. A light-emitting diode emits unpolarized light, whereas a laser light source can emit already-polarized light. Apparatus 500 is embodied in such a way that emitted light beam 530, after passing through polarizer 520, exhibits a predetermined polarization direction. This is illustrated in FIG. 5A by way of an arrow symbol for a first polarization state of emitted light beam 530 before passing through polarizer 520, and a circle symbol having two crossed lines therein for a second polarization state having the predetermined polarization direction of emitted light beam 530 after passing through polarizer 520.

After passing through polarizer 520, emitted light beam 530 that is furnished with the predetermined polarization direction strikes window 540. To be kept in mind here is the fact that the refraction conditions and reflections brought about by the window are not depicted in FIG. 5A, since they are of subordinate importance for purposes of the present invention. It is to be noted that in FIG. 5A, emitted light beam 530 strikes a water drop 545 after passing through window 540. If emitted light beam 530 did not strike water drop 545, it would be coupled out of window 540 and not reflected. Emitted light beam 530 experiences total reflection, or is reflected at least in part, at the interface of water drop 545 with the ambient air, and is sent back as reflected light beam 550. After passing again through window 540, reflected light beam 550 also possesses, in addition to the predetermined polarization direction, a component of depolarized light as illustrated by the dotted arrow in FIG. 5A. The depolarized light component derives from light scattering in water drop 545.

Reflected light beam 550 next strikes objective 560. Objective 560 can be, for example, a biconvex lens. After passing through objective 560, in which context reflected light beam 550 changes direction, it strikes analyzer 570. Analyzer 570 can have an effect comparable to that of polarizer 520. Analyzer 570 can be adjustable in terms of its polarizing effect on reflected light beam 550. In FIG. 5A, analyzer 570 is set so that only that component of reflected light beam 550 which has the predetermined polarization direction can pass through analyzer 570. After passing through analyzer 570, reflected light beam 550—which now encompasses only the light component having the predetermined polarization direction—strikes secondary image region 120 of image detector 100. In secondary image region 120 of image detector 100, a first secondary image is produced based on light having the predetermined polarization direction of reflected light beam 550.

FIG. 5B schematically depicts apparatus 500 of FIG. 5A according to an exemplifying embodiment of the present invention. The depiction in FIG. 5B corresponds to the depiction in FIG. 5A except for one discrepancy. The discrepancy is the fact that in FIG. 5B, analyzer 570 is set so that only the depolarized component of reflected light beam 550 can pass through analyzer 570. After passing through analyzer 570, reflected light beam 550—which now encompasses only the depolarized light component—strikes secondary image region 120 of image detector 100. In secondary image region 120 of image detector 100, a second secondary image is produced based on the depolarized light component of reflected light beam 550.

Apparatus 500 of FIGS. 5A and 5B is embodied to execute the method of FIG. 4 for determining a clarity of a window of a vehicle. To determine the clarity of the window of the vehicle, the first secondary image of FIG. 5A and the second secondary image of FIG. 5B are now compared with one another, and the result is evaluated.

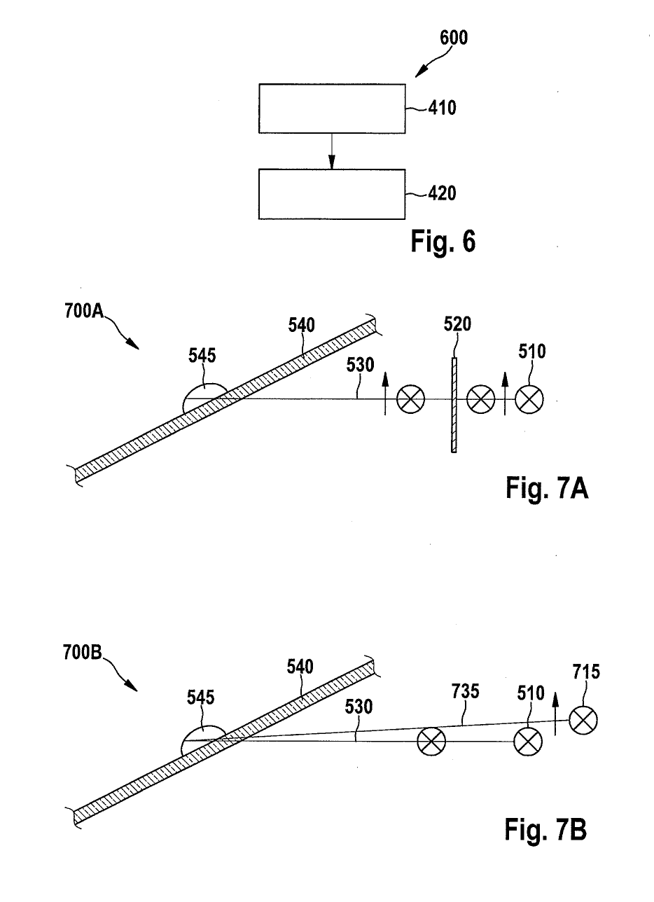

FIG. 6 is a flow chart of a method 600 for emitting at least one light beam suitable for determining a clarity of a window of a vehicle, according to an exemplifying embodiment of the present invention. Method 400 begins with a step of generating 410, using at least one polarized light source, at least one light beam furnished with a predetermined polarization. Additionally or alternatively, the at least one light beam can be generated using at least one polarizer. Method 400 then has a step of directing 420 onto the window the at least one light beam furnished with the predetermined polarization. The light beam then strikes the window. Method 600 can advantageously be carried out, for example, in conjunction with the image detector of FIG. 1 and with the rain sensor of FIGS. 3A and 3B.

FIG. 7A schematically depicts an apparatus 700A for emitting at least one light beam suitable for determining a clarity of a window of a vehicle, according to an exemplifying embodiment of the present invention. The depiction in FIG. 7A corresponds here to a depiction of a portion of FIGS. 5A and 5B. FIG. 7A shows light source 510, polarizer 520, emitted light beam 530, window 540, and water drop 545. The disposition of the elements and the path of emitted light beam 530 correspond to the depiction in FIGS. 5A and 5B. Light source 510 can have a light-emitting diode. In FIG. 7A, emitted light beam 530 can be set to different polarization states using the polarizer. The polarizer can be adjustable for this purpose, so that light beams having different polarization states can be generated in chronologically successive fashion with one and the same light source. Instead of an adjustable polarizer 520, multiple polarizers having differing polarization effects can also be used. Emitted light beam 530 can be unpolarized before passing through polarizer 520, and can be polarized only by polarizer 520. Emitted light beam 530 can also exhibit a specific polarization state before passing through polarizer 520, and its polarization state can be modified upon passage through polarizer 520. For this instance, light beam 530 has a different polarization state after passing through polarizer 520 than it did before passing through polarizer 520.

FIG. 7B schematically depicts an apparatus 700B for emitting at least one light beam suitable for determining a clarity of a window of a vehicle, according to an exemplifying embodiment of the present invention. The depiction in FIG. 7B is similar to the depiction in FIG. 7A, the polarizer having been omitted and an additional light source 715, which emits an additional emitted light beam 735 toward drop 545, being provided. Light sources 510, 715 can each emit polarized light; the polarization directions can be different. One of light sources 510, 715 can also emit polarized light, and the other unpolarized light. Using apparatus 700B of FIG. 7B, window 540 can be illuminated alternately or simultaneously with polarized and with unpolarized light, or alternatively or simultaneously with differently polarized light.

Apparatuses 700A and 700B of FIGS. 7A and 7B are respectively embodied to execute the method of FIG. 6 for emitting at least one light beam suitable for determining a clarity of a window of a vehicle.

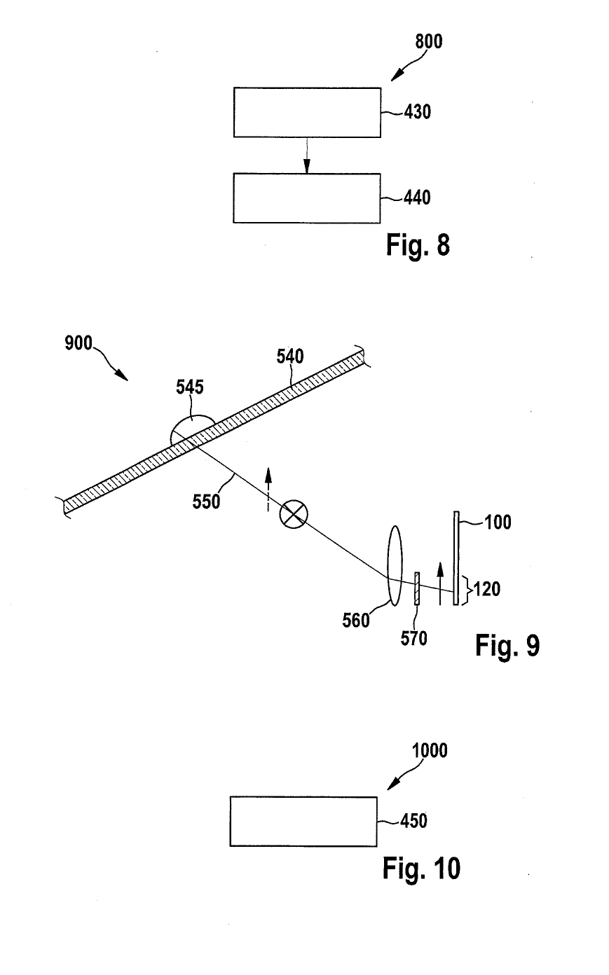

FIG. 8 is a flow chart of a method 800 for receiving at least one light beam suitable for determining a clarity of a window of a vehicle, according to an exemplifying embodiment of the present invention. A light beam is partly reflected by the window or by precipitation, dirt, and/or a defect on the outer side of the window. Method 400 has a step of polarizing 430, using at least one polarizer, at least one light beam deriving from the window in order to generate at least one light beam furnished with a predetermined polarization. Method 400 further has a step of sensing 440, using at least one detector, the at least one light beam furnished with the predetermined polarization. Method 800 can advantageously be executed, for example, in conjunction with the image detector of FIG. 1 and/or the rain sensor of FIGS. 3A and 3B.

FIG. 9 schematically depicts an apparatus 900 for receiving at least one light beam suitable for determining a clarity of a window of a vehicle, according to an exemplifying embodiment of the present invention. The depiction in FIG. 9 corresponds to a depiction of a portion of FIGS. 5A and 5B. FIG. 9 shows window 540, water drop 545, reflected light beam 550, objective 560, analyzer 570, image detector 100, and secondary image region 120. The disposition of the elements and the path of reflected light beam 550 correspond to the depiction in FIGS. 5A and 5B. Light beam 550 can originally have been generated by a light source that irradiates onto window 540 from the inside. Alternatively or additionally, the light beam can be produced by ambient light that strikes the window from outside. By suitable selection of analyzer 570, respectively suitable components of light beam 550 can be allowed to pass through to detector 100. Analyzer 570 can be adjustable in terms of its effect, so that different components of light beam 550 can be allowed to pass through in chronologically successive fashion to detector 100.

Apparatus 900 of FIG. 9 is embodied to execute the method of FIG. 8 for receiving at least one light beam suitable for determining a clarity of a window of a vehicle.

FIG. 10 is a flow chart of a method 1000 for determining a clarity of a window of a vehicle, according to an exemplifying embodiment of the present invention. The method has a step of evaluating 450 an information item of the at least one light beam furnished with the predetermined polarization, in order to determine the clarity of the window. Method 1000 can advantageously be executed, for example, in conjunction with the image detector of FIG. 1 and/or the rain sensor of FIGS. 3A and 3B.

The principles of various rain sensors, and the incorporation of the approach according to the present invention thereinto, will be described below with reference to the Figures.

One principle in rain sensors is the conventional optical method that utilizes total reflection. Light is emitted from a light-emitting diode (LED) and is coupled obliquely into the windshield by way of a coupling element. When the window is dry the light is totally reflected (once or repeatedly) at the outer side of the window and arrives at a receiver or detector in the form of a photodiode or light-dependent resistor (LDR). If water drops are present on the window, a portion of the light is outcoupled at the outer side of the window and results in a lower intensity at the receiver. The decrease in the quantity of light received at the LDR is an indication of the rain intensity. The more water that is present on the window, the greater the quantity of light coupled out and the lower the reflection. As a function of the quantity of rain detected, the vehicle's wiper system is controlled at a speed adapted to the wetting state of the windshield.

With increasing use of video systems in vehicles in order to implement driver assistance systems, for example night vision systems and warning video systems, the video-based rain sensor is becoming increasingly significant. One possibility for a video-based rain sensor involves evaluating a sharp image of the window using image processing technology. Either the camera can be focused onto the windshield, or an additional optical element, for example a lens, a mirror, or the like, can implement that focusing. In order to implement this refocusing the additional optical component can be integrated, for example, into the holding frame or housing of the camera.

The image of the focused raindrops on the window that is acquired by the automobile camera can be evaluated by an image processing algorithm, and the drops can be detected. This approach involves an entirely passive system. In certain ambient conditions this can lead to problems in terms of detection reliability. Detection becomes difficult specifically in situations with low ambient brightness or very low ambient contrast, for example in darkness, at night, in fog, etc. One possible approach to a solution involves alternating window illumination. Here the first optical radiation (the ambient radiation) is additionally supplemented with an active second optical radiation by way of an additional illumination source. In a context of very low ambient brightness, light beams proceeding from this second optical radiation can be reflected once or repeatedly at the raindrops, and a signal from the drops can thus be received even in the absence of a first optical radiation. This method does not, however, provide reliable drop detection under all ambient conditions.

According to the present invention, the relatively poor contrast in the context of the differential image method is improved by the fact that the illumination used for the second optical radiation involves working with polarized light or with multiple or adjustable polarization directions. In other words, for improved drop detection an additional second optical radiation 530 that emits polarized light is used. Using different—and, in particular, flat—angles of incidence for the light onto drop 545, very different reflections can take place for different polarization directions, for example in the vicinity of the Brewster angle. There are a variety of possibilities for implementing this additional polarized illumination source 510. For example, two LEDs or an LED matrix, having respectively mutually crossed polarizers 520 in front of them, can be used as illumination sources. Laser light sources would alternatively also be possible, since they already emit polarized light.

Twisted nematic liquid crystal displays (TN-LCDs) can also be used as controllable polarizers 520. The possibility exists here of using these as a polarizer 520 or an analyzer 570.

With such twisted nematic (TN) cells the polarization direction can be adjusted between 0 and 90°, and is thus actively controllable via a corresponding applied voltage. An LCD having a full-coverage electrode is also sufficient for this application, and a matrix display is not necessary.

Image region 120, or a specific region of the imager array that is to be used for the secondary image, can additionally be equipped with an upstream analyzer 570 of this kind, e.g. once again an LCD cell. Several possibilities are thus available for utilizing polarization in the context of the evaluation of image sequences.

For example, two images can be acquired, the first being acquired with an illumination having a specific polarization direction and the second with an illumination in which the polarization is normal to the first. Drops 545 on window 540 produce different reflections depending on the illuminating polarization direction. The reliability of drop detection is enhanced, as compared with the normal differential image method, by evaluating two images with differently polarized illumination.

If the TN cell is (also) used as analyzer 570, drops 545 are illuminated by the unpolarized ambient light or by an additional polarized or unpolarized illumination source 510; 715. Here camera 210 would acquire differing drop images in different polarization states, which can also be evaluated using a differential method.

Light is also depolarized by scattering at drop 545. It is therefore advantageous to acquire drop images in which the received polarization direction is normal to the emitted one. This would be an indication of the degree of depolarization. These images can be compared with the drop images of the parallel direction. Such actions become possible when transmission sources 510 and analyzer 570 are synchronized with controllable polarizers 520.

These two above-described possibilities not only can be carried out with two images of differing polarization, but also can utilize a rotating polarization, in which context an image sequence made up of multiple images of slightly modified polarization is evaluated.

Advantages include not only installation space optimization, a functionality better adapted to human perception capabilities, the larger sensitive area, and the smaller window area required for attachment, but also better utilization of an illumination that is already present. Illumination with polarized light converts the passive system of the video-based rain sensor into an active system.

The exemplifying embodiments described and shown in the Figures are selected merely by way of example. Different exemplifying embodiments can be combined with one another entirely or with respect to individual features. An exemplifying embodiment can also be supplemented with features of a further exemplifying embodiment.

If an exemplifying embodiment encompasses an “and/or” combination between a first feature/step and a second feature/step, this can be read to mean that the exemplifying embodiment according to one embodiment encompasses both the first feature/first step and the second feature/second step, and according to a further embodiment encompasses either only the first feature/first step or only the second feature/second step.

1-10. (canceled)

11. A method for determining a clarity of a window of a vehicle, comprising:
evaluating an information item of at least one light beam provided with a predetermined polarization in order to determine the clarity of the window.

12. A method for emitting at least one light beam configured for determining a clarity of a window of a vehicle, comprising:
directing onto the window the at least one light beam, wherein the at least one light beam is provided with a predetermined polarization.

13. The method as recited in claim 12, further comprising:
generating, using at least one polarized light source, the at least one light beam provided with the predetermined polarization.

14. The method as recited in claim 12, further comprising:
generating, using at least one polarizer, the at least one light beam provided with the predetermined polarization.

15. A method for receiving at least one light beam configured for determining a clarity of a window of a vehicle, comprising:
polarizing, using at least one polarizer, a light beam which represents a light beam deriving from the window, in order to generate at least one light beam provided with a predetermined polarization; and
sensing, using a detector, the at least one light beam provided with the predetermined polarization.

16. The method as recited in claim 15, wherein:
in the polarizing step, the light beam which represents the light beam deriving from the window is polarized using a polarizer which has adjustable polarizing effect, in order to generate chronologically successive light beams having different predetermined polarizations; and
in the sensing step, the chronologically successive light beams having different predetermined polarizations are sensed using the detector.

17. The method as recited in claims 16, wherein the at light beam deriving from the window represents a light beam which has penetrated through the window at least once.

18. A method for identifying a clarity of a window of a vehicle, comprising:
generating, using at least one polarized light source, at least one light beam provided with a predetermined polarization;
directing onto the window the at least one light beam provided with the predetermined polarization;
sensing, using a detector, the at least one light beam provided with the predetermined polarization; and
evaluating an information item of the at least one light beam provided with the predetermined polarization in order to determine the clarity of the window.

19. An apparatus for determining a clarity of a window of a vehicle, comprising:
at least one polarized light source configured to (i) generate at least one light beam provided with a predetermined polarization, and (ii) direct onto the window the at least one light beam provided with the predetermined polarization;
a detector configured to sense the at least one light beam provided with the predetermined polarization; and
an evaluator configured to evaluate an information item of the at least one light beam provided with the predetermined polarization in order to determine the clarity of the window.

20. A non-transitory computer-readable data storage medium storing a computer program having program codes which, when executed on a computer, performs a method for identifying a clarity of a window of a vehicle, the method comprising:
generating, using at least one polarized light source, at least one light beam provided with a predetermined polarization;
directing onto the window the at least one light beam provided with the predetermined polarization;
sensing, using a detector, the at least one light beam provided with the predetermined polarization; and
evaluating an information item of the at least one light beam provided with the predetermined polarization in order to determine the clarity of the window.
